(19) United States
(12) Patent Application Publication
(10) Pub. No.: US 2024/0109134 A1
(43) Pub. Date: Apr. 4, 2024

(54) TOOL CONNECTING ROD

(71) Applicant: YING-MO LIN, Nantou County (TW)

(72) Inventor: YING-MO LIN, Nantou County (TW)

(21) Appl. No.: 18/366,209

(22) Filed: Aug. 7, 2023

(30) Foreign Application Priority Data
Sep. 30, 2022 (TW) 111137131

(51) Int. Cl. B23B 31/00; B25B 23/00

(52) U.S. Cl. CPC B23B 31/005; B25B 23/0035

(57) ABSTRACT

A tool connecting rod is provided, including: a rod, a first sleeve member, a second sleeve member, an elastic member, a first magnetic member and a restriction mechanism. The rod has an insertion groove. The first sleeve member is tubular and slidably sleeved to the rod, and the first sleeve member includes an assembling end portion. The second sleeve member is slidably sleeved to the first sleeve member. The elastic member is disposed on one of the first sleeve member and the second sleeve member and radially abutted against the other one of the first sleeve member and the second sleeve member. The elastic member is located between an outer circumferential surface of the first sleeve member and an inner circumferential surface of the second sleeve member. The first magnetic member is disposed on the assembling end portion.

### BACKGROUND OF THE INVENTION

### Field of the Invention

The present invention relates to a tool connecting rod.

### Description of the Prior Art

A conventional tool connector, such as disclosed in Taiwan patent No. 1501841, the tool connector includes a rod, a socket, an engaging member, a sleeve member and a second elastic member. The socket is sleeved to the rod, and an outer side of the socket has a first threaded segment. An end of the engaging member is screwed on the first threaded segment so that the engaging member is axially adjustable relative to the socket. The sleeve member is axially slidably disposed on the rod, and a front end of the sleeve member has a magnetic ring disposed thereon. Two ends of the second elastic member are respectively abutted against a rear end of the sleeve member and a shoulder portion of the rod so that the sleeve member has a tendency to move in a direction toward the front end of the sleeve member.

However, the socket and the engaging member have to be processed to have threaded structures, which requires numerous processing procedures; and the socket and the engaging member are rotated relative to each other for adjustment, which is inconvenient to use. Moreover, the sleeve member is moved in the direction toward the front end and protrudes beyond the rod so that the sleeve member has to be pressed to compress the second elastic member and be close to an insertion hole for assembling a tool bit thereto. If the sleeve member is not pressed, a through hole of the magnetic ring is too far away from the insertion hole to easily insert the tool bit, which is inconvenient. In addition, the sleeve member is easy to be deflected when being pressed, which causes that the sleeve member cannot be smoothly move relative to the rod. Therefore, the conventional tool connector requires multiple installation steps, which cannot be installed quickly and is inconvenient to use

The present invention is, therefore, arisen to obviate or at least mitigate the above-mentioned disadvantages.

### SUMMARY OF THE INVENTION

The main object of the present invention is to provide a tool connecting rod, which provides fast and multi-stage adjustment, easy processing and a simple structure and is easy to install a tool bit.

To achieve the above and other objects, the present invention provides a tool connecting rod, including: a rod, a first sleeve member, a second sleeve member, an elastic member, a first magnetic member and a restriction mechanism. The first sleeve member is tubular and slidably sleeved to the rod, and the first sleeve member includes an assembling end portion. The second sleeve member is slidably sleeved to the first sleeve member. The elastic member is disposed on one of the first sleeve member and the second sleeve member and radially abutted against the other one of the first sleeve member and the second sleeve member. The elastic member is located between an outer circumferential surface of the first sleeve member and an inner circumferential surface of the second sleeve member. The first magnetic member is disposed on the assembling end portion. The restriction mechanism is disposed on the rod and located between an outer circumferential surface of the rod and an inner circumferential surface of the first sleeve member. The rod extends in an axial direction, and the first sleeve member has an engaging portion radially extending inward. The engaging portion is engageable with the restriction mechanism in the axial direction. The restriction mechanism is located between the assembling end portion and the engaging portion in the axial direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIGS. 3-5 are drawings showing operation according to a preferable embodiment of the present invention; and

FIG. 6 is a drawing of a preferable embodiment of the present invention in use.

### DETAILED DESCRIPTION OF THE PREFERRED EMBODIMENTS

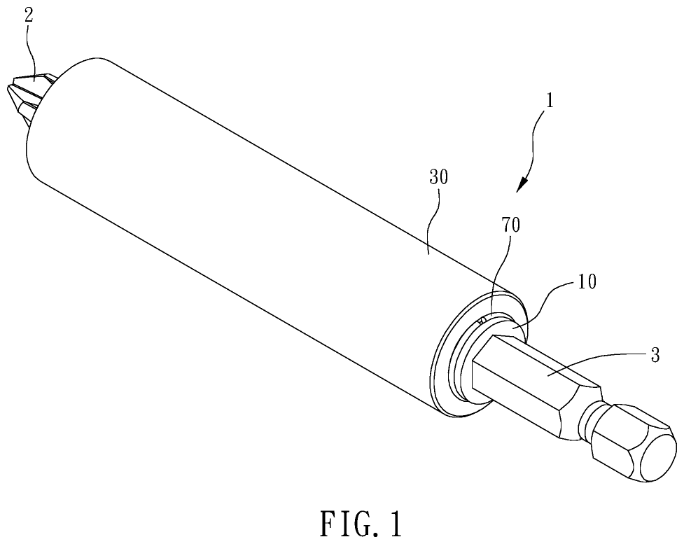

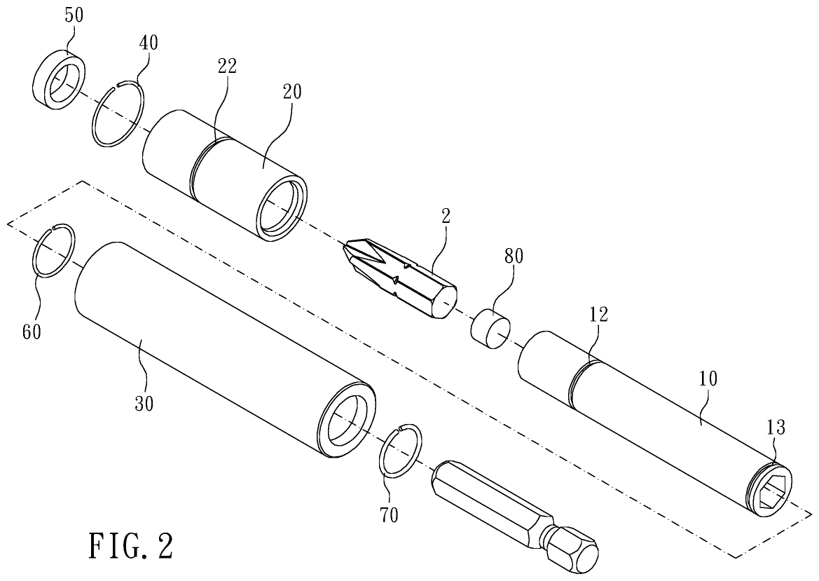

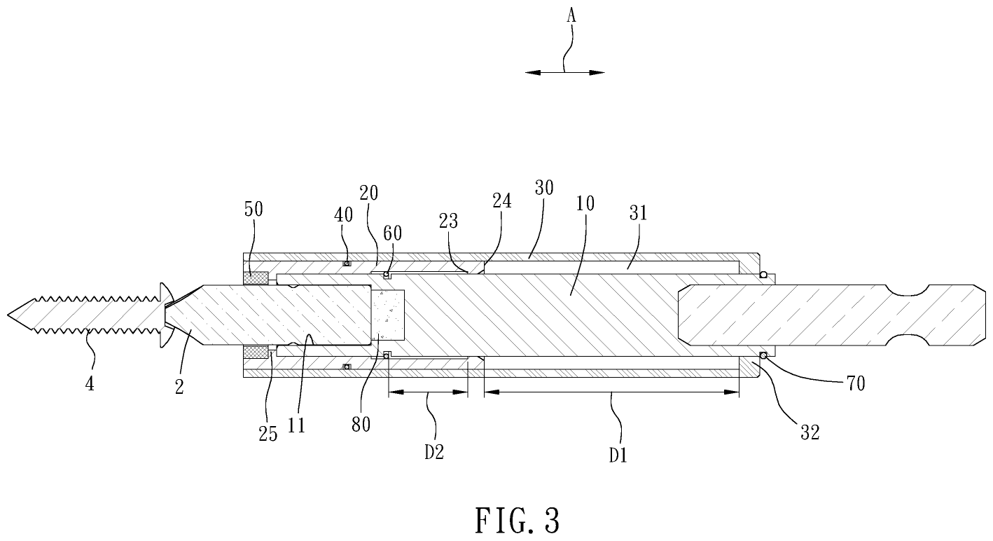

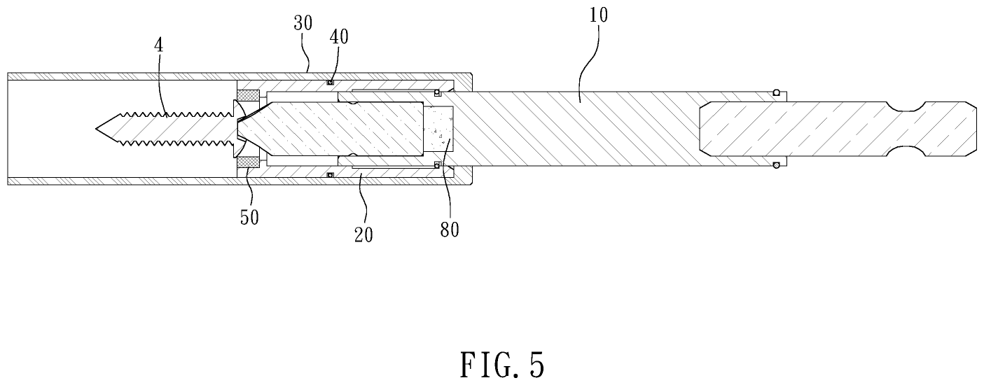

Please refer to FIGS. 1 to 6 for a preferable embodiment of the present invention. A tool connecting rod 1 of the present invention includes a rod 10, a first sleeve member 20, a second sleeve member 30, an elastic member 40 and a first magnetic member 50.

The rod 10 has an insertion groove 11 disposed thereon. The first sleeve member 20 is tubular and slidably sleeved to the rod 10, and the first sleeve member includes an assembling end portion 21. The second sleeve member 30 is slidably sleeved to the first sleeve member 20. The elastic member 40 is disposed on one of the first sleeve member 20 and the second sleeve member 30 and radially abutted against the other one of the first sleeve member 20 and the second sleeve member 30. The elastic member 40 is located between an outer circumferential surface of the first sleeve member 20 and an inner circumferential surface of the second sleeve member 30, and the elastic member 40 is a C-shaped retainer. The first magnetic member 50 is disposed on the assembling end portion 21, and the first magnetic member 50 is ring-shaped. Therefore, a tool bit 2 is easy to be assembled to the insertion groove 11 of the tool connecting rod 1, which provides fast and multi-stage adjustment, easy processing and a simple structure and is easy to operate.

Specifically, the elastic member 40 is elastically and radially abutted against and between the first sleeve member 20 and the second sleeve member 30 so as to be axially co-movable. In addition, the first sleeve member 20 is axially movable and positionable relative to the rod 10, which is convenient to rapid assembling, disassembling a tool bit 2 to the insertion groove 11. The first sleeve member 20 can be moved forward to connected with a fastener 4 attracted to the tool bit 2 by the first magnetic member 50, and the second sleeve member 30 is movable relative to the first sleeve member 20 to sleeve around the fastener 4 so as to catch the fastener 4 falling from the tool bit 2.

One of the outer circumferential surface of the first sleeve member 20 and the inner circumferential surface of the second sleeve member 30 has an annular groove 22 disposed thereon, and the elastic member 40 is engaged within the annular groove 22. In this embodiment, the outer circumferential surface of the first sleeve member has the annular groove 22. Preferably, the inner circumferential surface of the second sleeve member 30 is radially abutted against the outer circumferential surface of the first sleeve member 20 so as to increase a contact area between the second sleeve member 30 and the first sleeve member 20 for smooth and stable movement.

The tool connecting rod 1 further includes a restriction mechanism 60, and the restriction mechanism 60 is disposed on the rod 10 and located between an outer circumferential surface of the rod 10 and an inner circumferential surface of the first sleeve member 20. The rod 10 extends in an axial direction A, and the first sleeve member 20 has an engaging portion 23 radially extending inward. The engaging portion 23 is engageable with the restriction mechanism 60 in the axial direction A. The restriction mechanism 60 is located between the assembling end portion 21 and the engaging portion 23 in the axial direction A. Therefore, the restriction mechanism 60 can block the first sleeve member 20 from being moved in a direction toward the assembling end portion 21.

In this embodiment, the outer circumferential surface of the rod 10 has a first annular groove 12 recessed thereon, and the restriction mechanism 60 is engaged within the first annular groove 12. In this embodiment, the restriction mechanism 60 is a C-shaped retainer, and the restriction mechanism 60 is radially and elastically abutted against the inner circumferential surface of the first sleeve member 20 so that the rod 10 and the first sleeve member 20 are movable relative to each other and positionable by the restriction mechanism 60.

The second sleeve member 30 has a receiving hole 31, and the first sleeve member 20 is disposed within the receiving hole 31. In the axial direction, a length of the receiving hole 31 is larger than a length of the first sleeve member 20. The second sleeve member 30 has a protruding portion 32 extending radially, the first sleeve member 20 includes an abutting portion 24 extending radially, and the protruding portion 32 and the abutting portion 24 are abuttable against each other in the axial direction A, which allows the second sleeve member 30 to be restricted by the first sleeve member 20 in the axial direction A and not detached therefrom. Preferably, the protruding portion 32 and the abutting portion 24 define a first maximum distance D1 therebetween, and the restriction mechanism 60 and the engaging portion 23 define a second maximum distance D2 therebetween. The first maximum distance D1 is larger than the second maximum distance D2 so that a movable range of the first sleeve member 20 relative to the rod 10 is smaller than that of the second sleeve member 30 relative to the rod 10. When the first sleeve member 20 is blocked by the restriction mechanism 60, the second sleeve member is still movable relative to the first sleeve member 20 and the rod 10 to protrude beyond the first sleeve member 20 and the rod 10 so as to sleeve around the fastener 4.

The tool connecting rod 1 further includes a restricting portion 70, and the restricting portion 70 is disposed on an end portion of the rod 10 remote from the insertion groove 11. The second sleeve member 30 is abuttable against the restricting portion 70 in a direction remote from the insertion groove 11 in the axial direction A. In this embodiment, the restricting portion 70 is an engaging ring; the outer circumferential surface of the rod 10 has a second annular groove 13 recessed thereon, the second annular groove 13 is spaced apart from the first annular groove 12 in the axial direction A, and the restricting portion 70 is engaged within the second annular groove 13. Therefore, the second sleeve member 30 will not be detached from the rod 10 in a direction remote from the insertion groove 11.

The assembling end portion 21 has a receiving groove 26, and the first magnetic member 50 is disposed within the receiving groove 26 and abutted against a bottom surface defining the receiving groove 26 so that the first magnetic member 50 is stably positioned and supported.

The tool connecting rod 1 further includes a second magnetic member 80, and the second magnetic member 80 is disposed in the rod 10 and corresponds to the insertion groove 11 so as to magnetically attract the tool bit 2 inserted within the insertion groove 11.

The inner circumferential surface of the first sleeve member 20 includes an annular flange 25, and the annular flange 25 is located between the first magnetic member 50 and an end portion of the rod 10. The annular flange 25 is abuttable against the rod 10 in the axial direction A so as to block the first sleeve member 20 from being moved in a direction remote from the first magnetic member 50.

An end of the rod 10 remote from the insertion groove has a polygonal slot configured for a insertion rod 3 to be inserted therewithin, and the insertion rod 3 is connected with and driven by a driving tool (such as a pneumatic tool).

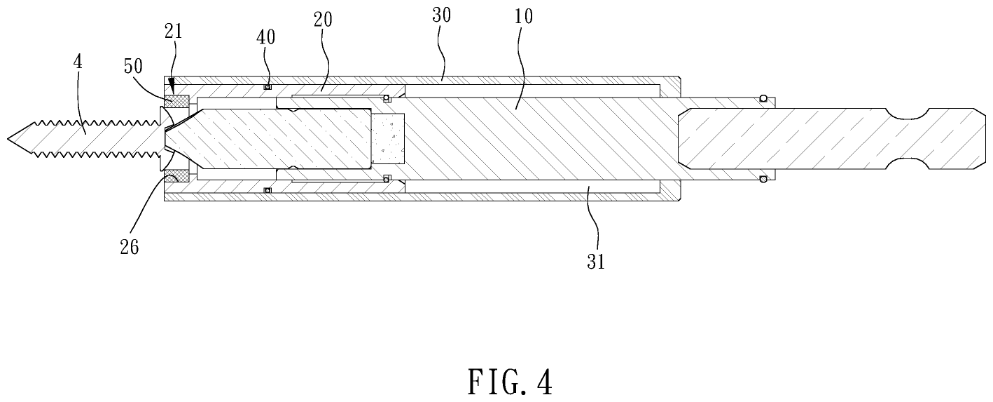

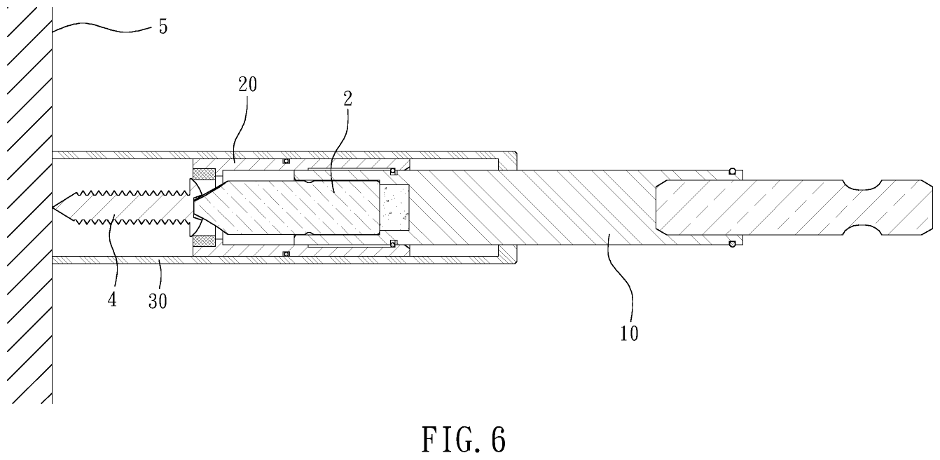

In operation, the tool bit 2 is inserted into the insertion groove 11, the tool bit 2 is connected with the fastener 4, the second sleeve member 30 is moved axially to drive the first sleeve member 20 to move in a direction toward the fastener 4 relative to the rod 10, and the first magnetic member 50 magnetically attracts the fastener 4 (as shown in FIG. 4). When the engaging portion 23 of the first sleeve member 20 is axially engaged with the restriction mechanism 60 and unmovable in a direction toward the fastener 4, the second sleeve member 30 is moved to resist an elastic force of the elastic member 40 so as to move relative to the first sleeve member 20 and protrude beyond the rod 10 for stable and smooth operation. When the fastener 4 falls from the tool bit 2, the fastener 4 can be caught by the second sleeve member 30, and the second sleeve member 30 is abuttable against a basement 5 (such as a wall, ground, or the like, as shown in FIG. 6) for stable support and to avoid over-tightening.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool connecting rod, including:
a rod, having an insertion groove disposed thereon;
a first sleeve member, being tubular and slidably sleeved to the rod, the first sleeve member including an assembling end portion;
a second sleeve member, slidably sleeved to the first sleeve member;
an elastic member, disposed on one of the first sleeve member and the second sleeve member and radially abutted against the other one of the first sleeve member and the second sleeve member, located between an outer circumferential surface of the first sleeve member and an inner circumferential surface of the second sleeve member;
a first magnetic member, disposed on the assembling end portion; and
a restriction mechanism, disposed on the rod and located between an outer circumferential surface of the rod and an inner circumferential surface of the first sleeve member, the rod extending in an axial direction, the first sleeve member having an engaging portion radially extending inward, the engaging portion being engageable with the restriction mechanism in the axial direction;
wherein the restriction mechanism is located between the assembling end portion and the engaging portion in the axial direction.

2. The tool connecting rod of claim 1, wherein the elastic member is a C-shaped retainer.

3. The tool connecting rod of claim 1, wherein one of the outer circumferential surface of the first sleeve member and the inner circumferential surface of the second sleeve member has an annular groove disposed thereon, and the elastic member is engaged within the annular groove.

4. The tool connecting rod of claim 1, wherein the restriction mechanism a C-shaped retainer, and the restriction mechanism is radially and elastically abutted against the inner circumferential surface of the first sleeve member.

5. The tool connecting rod of claim 1, wherein the second sleeve member has a receiving hole, the first sleeve member is disposed within the receiving hole; in the axial direction, a length of the receiving hole is larger than a length of the first sleeve member; the second sleeve member has a protruding portion extending radially, the first sleeve member includes an abutting portion extending radially, and the protruding portion and the abutting portion are abuttable against each other in the axial direction.

6. The tool connecting rod of claim 1, wherein the second sleeve member has a receiving hole, the first sleeve member is disposed within the receiving hole; in the axial direction, a length of the receiving hole is larger than a length of the first sleeve member; the second sleeve member has a protruding portion extending radially, the first sleeve member includes an abutting portion extending radially, and the protruding portion and the abutting portion are abuttable against each other in the axial direction; the protruding portion and the abutting portion define a first maximum distance therebetween, the restriction mechanism and the engaging portion define a second maximum distance therebetween, and the first maximum distance is larger than the second maximum distance.

7. The tool connecting rod of claim 1, further including a restricting portion, wherein the restricting portion is disposed on an end portion of the rod remote from the insertion groove, and the second sleeve member is abuttable against the restricting portion in a direction remote from the insertion groove in the axial direction.

8. The tool connecting rod of claim 1, wherein the inner circumferential surface of the first sleeve member includes an annular flange, the annular flange is located between the first magnetic member and an end portion of the rod, and the annular flange is abuttable against the rod in the axial direction.

9. The tool connecting rod of claim 6, wherein the inner circumferential surface of the second sleeve member is radially abutted against the outer circumferential surface of the first sleeve member; the elastic member is a C-shaped retainer; the outer circumferential surface of the first sleeve member has an annular groove disposed thereon, the elastic member is engaged within the annular groove; the restriction mechanism is a C-shaped retainer, and the restriction mechanism is radially and elastically abutted against the inner circumferential surface of the first sleeve member; the outer circumferential surface of the rod has a first annular groove recessed thereon, the restriction mechanism is engaged within the first annular groove; the tool connecting rod further includes a restricting portion, the restricting portion is disposed on an end portion of the rod remote from the insertion groove, and the second sleeve member is abuttable against the restricting portion in a direction remote from the insertion groove in the axial direction; the restricting portion is an engaging ring; the outer circumferential surface of the rod has a second annular groove recessed thereon, the second annular groove is spaced apart from the first annular groove in the axial direction, the restricting portion is engaged within the second annular groove; the inner circumferential surface of the first sleeve member includes an annular flange, the annular flange is located between the first magnetic member and an end portion of the rod, and the annular flange is abuttable against the rod in the axial direction; the assembling end portion has a receiving groove, the first magnetic member is disposed within the receiving groove and abutted against a bottom surface defining the receiving groove; and the tool connecting rod further includes a second magnetic member, and the second magnetic member is disposed in the rod and corresponds to the insertion groove.
